(19) United States
(12) Patent Application Publication
(10) Pub. No.: US 2001/0034647 A1
(43) Pub. Date: Oct. 25, 2001

(54) Providing benefits by the internet to minimally identified users

(76) Inventors: Michael B. Marks, South Orleans, MA (US); Joel Marks, Sherman Oaks, CA (US)

Correspondence Address: Brad I Golstein, Metro88, 20755 Plummer Street, Chatsworth, CA, 91311, US

(21) Appl. No.: 09/774,559

(22) Filed: Feb. 1, 2001

Related U.S. Application Data
(60) Provisional application No. 60/179,928, filed on Feb. 3, 2000.

(51) Int. Cl. G06F 17/60

(52) U.S. Cl. 705/14

(57) ABSTRACT

An incentive benefit program compensates users for viewing advertising, participating in surveys and similar activities. A user releases no inherently valuable information, such as an email or home address or credit card number, to any additional entities to receive benefits. The user remains substantially anonymous to the benefit provider, providing an identity for an account that is not directly usable by a third party for contacting the user or for gaining monetarily from the user. Such less valuable account identities may include numbers for programs for frequent flyers, video rental clubs, and grocery discount cards. Third parties that operate these programs may hold inherently valuable information about the user, however since the user already belongs to the program, no additional operators need gain this information. The user need disclose only a relatively non-valuable third party benefits account number to the benefit provider.

### FIELD OF THE INVENTION

The present invention concerns methods whereby users of the Internet or other networks may receive benefits substantially anonymously in conjunction with advertising and purchases of products and services.

### BACKGROUND OF THE INVENTION

Many commercial ventures on the Internet today are supported by the expectation that advertising can both cover the cost of the venture and generate a profit. Advertising in the form of banners and buttons adorns web pages in the hope of luring a web page visitor to an advertiser's site. The intent of this form of advertising is a mix between highway billboard and magazine display ad. The goal of a banner ad is thus to detour a web surfer from his or her chosen destination to the destination of the advertiser. In this sense, stopping along the “information superhighway” prior to reaching one's destination, is akin to pulling off a real highway for gas, food or lodging. During the stop a traveler's mind tends to remain focused on the destination and not on the detour; a consequence is a desire to make the detour as short as possible. It may therefore be difficult for advertisers to deliver meaningful messages to people seeking information on the Internet. The value of Internet advertising suffers as a result.

Clicking on a banner the viewer may be transported to a web site maintained by the advertiser where a full advertising message may be delivered. Generally, the advertiser pays a fee to the web site owner (directly or through an intermediary) on the basis of either 1) numbers of “hits” or “page views” on a web page where the banner is displayed or 2) clicks or “click-thrus” on the banner itself. Since a banner conveys limited information advertisers place less value on page views than on click-thrus.

Users of the Internet have increasingly valued privacy. In fact certain web sites offer benefits specifically tied to users disclosing their identity directly at the web site. This identity includes at least the user's email address, and may also include a home address and telephone number. Further, typical web sites that provide or enable benefits require the use, and thus memorization of, a user name and password.

Angles (U.S. Pat. No. 5,933,811) presents a system and method for delivering customized advertisements within interactive communications systems. A primary goal of Angles is to generate a list of advertising to be sent to specified target audiences. To achieve this, Angles discloses a means for delivering advertising matched to profiles of given users. A consumer's demographic information is stored on the computer of the advertisement provider; this is achieved by a user registering with the advertisement provider and providing details about his or her own background and interests. When a user accesses a given web site, the user is known either through having registered with the web site or through an identifier that was previously attached to the user's web browser. Once known, the user may then receive customized advertisements from the web site. The advertisement provider may subsequently monitor the activities of the user at the web site. This monitoring may be used for billing purposes. Another component of Angles' disclosure is the requirement that advertisers register their content with the advertisement provider to create information content from which customized advertisements may be drawn.

Merriman (U.S. Pat. No. 5,948,061) discloses a method for delivering advertising to users by means of an advertisement server that responds to requests from a user's device. In a typical embodiment Merriman discloses a method whereby a user with a PC may visit a web site with media content and a space allocated for advertising. The web site sends a link message to the user's PC. The user's PC then forwards the link message to an advertising server requesting delivery of an advertisement to fill the advertising space provided by the web site. The advertisement is then delivered onto the user's PC screen into the space provided for advertising by the web site. Merriman further discloses a method for knowing how often a given advertisement is displayed and how often a given user has seen a given advertisement. Start and stop dates may be set for displaying given ads in response to tracking information.

Goldhaber (U.S. Pat. No. 5,794,210) discloses an attention brokerage to track a user's preferences through advertising. A user may receive benefits for paying attention to advertising. The operator of the benefits program may create the list of targeted advertising. A user provides his identity to the operator in the disclosed embodiment. To receive benefits for viewing advertising the user logs in to the benefits program web site or otherwise enables his identity to be established. Recognizing the value of targeted advertising in another manner have been companies such as FreePC. FreePC offered free computers along with free Internet access in return for the opportunity to deliver targeted advertising. Users who signed up with FreePC were required to provide a detailed personal profile, agree to spend a number of hours per month on the internet and tolerate a space on their computer monitor devoted exclusively to advertising. FreePC provided a permanent window frame for advertising through which all Internet information was viewed. Advertising correlated to stated preferences could then be delivered to the window frame on a user's screen.

Advertising may actually comprise a significant part of the value for items sold on the mass market. Investment in advertising may become equity in the form of good will. Building good will may therefore be a meaningful goal for mass-market advertisers. Companies may generate good will and prompt responses by offering discounts and valuable goods and services to people who reply in a given manner. Many companies now make such incentive offers regularly. For example, in return for signing up for service, companies such as Sprint, MCI and AT&T have offered consumers frequent flier miles, free calling time and even cash. McDonald's has offered toys such as Beanie Babies to customers who buy meals. Business Week has given away products such as calculators to people who sign up for subscriptions. In addition to giving incentives for purchasing goods and services, incentives may even be given for simply providing requested information. In all of these examples the consumer must respond in a manner specified by the company in order to receive the incentive. Generally, the company chooses the incentive made available to the consumer; this is true even if the incentive is something fungible such as frequent flier miles or cash.

A complementary goal of advertising is to promote loyalty to a given company's services and products. In furthering this goal companies such as airlines offer frequent flier miles. Airline passengers may build up miles in a personal account corresponding to miles flown with a given airline. When the accumulated miles reach certain thresholds they may be spent on airline tickets and ticket upgrades. Likewise some credit card companies may give consumers points for every dollar spent using the company's credit card. Accumulated points may be spent on products and services or even converted into airline miles for various airlines. Diner's Club, for example, gives card members one point for every dollar purchased using the card; accumulated points may be transferred at the rate of two points per mile and applied to frequent flier accounts on any airline.

Credit card points and frequent flier miles give consumers incentives to utilize services and purchase goods that help them accumulate compatible points and miles most quickly. Flying on a single airline or using a single credit card over utilizing alternatives may accomplish this.

Discounts and incentives common in the bricks and mortar world have found counterparts on the Internet. Mypoints.com rewards consumers for reading and responding to targeted offers and surveys at the www.mypoints.com web site and through email advertising: consumers may collect points which can be redeemed for a wide variety of products and services.

Netcentives.com also offers frequent flier miles and credits that may be redeemed for products. Netcentives has been assigned U.S. Pat. No. 5,774,870 by Storey. Storey discloses a method for delivering incentives to users who shop on-line. A user may enroll in an incentive program at a given web site. The given web site and other web sites associated with the program may then award credits in the form of award points when the user purchases products. In another incarnation, disclosed at Netcentives.com, a user may earn award points for touring a demonstration of Netcentives' ClickRewards program. Award points may be redeemed for products or frequent flier miles.

Another form of incentive is a contest that rewards responses in the manner of a lottery. An example of this incentive is a radio contest. Such a contest may offer $100 to the 100th caller to a radio station in the period immediately following the broadcast of a certain song. The callers themselves who, calling independently from different locations, do not know when the 100th call will be placed provide a random aspect to this incentive. Radio listeners are given an incentive to listen carefully to the radio station's broadcast so that they not miss hearing the song and knowing when to respond; only by knowing when the song has been played may a listener infer the right time to place a call and become a potential winner. In this way the radio station may increase its audience of listeners (and the level of audience attention to its broadcast) and create additional value to advertisers. Iwon.com gives away $10,000 each day (and $1,000,000 on April 15) to visitors to its web site. By giving away money Iwon.com seeks to lure visitors who may then view advertising and, in turn, profit from the generation of advertising revenue.

Further variations on these themes can be found at the web sites of Dash.com, Beenz.com and Pointclick.com.

In common, all of the prior art incentives programs require a user to sign up with a program administrator in order to earn benefits. The sign up procedure usually requires the user to divulge private information that may be used for targeting advertising and product offers. Moreover the sign up procedure can be time consuming.

Prior art Internet incentives programs generally meet the range of user preferences by offering a list of incentives from which the user may select. The list may include programs for frequent flier miles, car rentals, hotel stays, entertainment offers, charities, cash rewards and credits that may be redeemed for products and services and more. In attempting to meet the full range of user preferences, the prior art responds by lengthening the list. Adding choices in this manner adds complexity to the process of choosing an incentive program.

Advertising incentives generally seek to prompt responses, obtain user identity information, build a market and generate goodwill. Incentives provided by one advertiser are generally not linked to incentives provided by other advertisers. Additionally, advertisers themselves determine the incentives they will provide.

To participate in currently available incentive programs a user registers on a web site, providing at least his email address. He is issued a password that must be entered for later participation in the program. The operator of the benefits program is able to directly contact a user without the user first contacting the operator. The user is thus exposed to the benefit system operator.

### SUMMARY

It is of value to an Internet user that he retains the option that the operators of the various Internet sites that he visits cannot contact him. The prior art do not provide methods for a user to obtain benefits anonymously through activities on the Internet. In the present invention a user provides identifying information that is useful solely for distributing benefits. The operator of the incentive benefits system obtains no information from a user that can allow the operator to initiate contact to a user. When a user acts upon a web site or icon controlled or provided by the benefits operator, he is associated with account information only by a cookie or equivalent data stored in his web browser.

According to one embodiment of the invention anonymous account information comprises any account number or name that cannot be directly used for monetary transactions or as a direct method to contact a person. Such an account will be part of a preexisting benefit or discount program to which the user has already identified himself. The operators of such third party benefits programs will in most cases have the ability to contact the user. However an improvement of the invention is that a participant in an Internet benefits incentive program need not directly identify himself to an additional entity to receive benefits. Only third party operators that were already able to contact the user are used.

In a further embodiment of the invention a user may identify and designate a further beneficiary to receive the benefits. In this case the further beneficiary would normally be able to be contacted directly by the benefit incentive operator. However the user would remain anonymous.

According to the present invention the benefits operator does not track a user's web habits or collect any data on a user beyond the anonymous account information. Tracking users' web viewing habits is a well-known method for Internet advertisers. The benefit program of the present invention may be used to enhance responses to advertising by providing incentives to users to respond to ads. However an advantage of the present invention is that it does not compete with the existing advertising providers. In a preferred embodiment the benefits operator does not know which ads are being viewed, only that an ad viewing will require a benefit to be paid. The ad providers retain their exclusive function of compiling a database on user viewing habits and determining which ads to place.

Further, since the user remains substantially anonymous to the benefits provider, the user will require less compensation when using the benefits system compared to prior art benefit systems where user is exposed to the benefit operator.

The less intrusive registration process provides a further benefit to the user since an anonymous system enables faster, easier benefits registration. The present invention allows a user to claim benefits faster, thus helping to maximize the value of the benefits.

An existing Internet ad provider will realize more value when associated with the benefit program of the present invention compared to the prior art benefit programs, which may compete with the ad providers and require higher compensation levels.

The present invention recognizes that offering a given unit of value in different ways motivates more users than offering that unit of value in the same way. Therefore, for a given unit of value, the benefits program of the present invention offers a unique combination of benefits offers to capture the varying predilections of different users.

It is desirable for a user to be presented with a limited number of choices so that the process of choosing does not become an encumbrance. It is furthermore desirable for a marketer to have the ability to create a custom list of incentives choices that particularly suit the marketer's target audience. The present invention provides a means whereby marketers may offer users a simple, short, pre-edited list of incentive offers which may meet their particular interests and demographics.

Use of the present invention may enhance the value of advertising to advertisers, consumers and intermediaries. The present invention may thus encourage further development of advertising supported services and help to sustain services that are currently offered.

### SUMMARY DESCRIPTION OF THE DRAWINGS

FIG. 1 shows the process whereby an advertisement is coupled with an identified icon that signifies participation in the benefits program.

FIG. 2 shows the process whereby an advertiser creates a benefits offer (referred to as a “benefits box”) for inclusion in the benefits program.

FIG. 3 shows the response of the benefits program to an action by a user upon an icon.

FIG. 4 shows the process of a user claiming a benefit.

FIG. 5 shows the process whereby the benefits manager delivers the user's benefit to a selected benefit program.

FIG. 6 shows the relationships between a user and his or her actions upon an icon and an additional benefits claim field.

### DETAILED DESCRIPTION OF THE INVENTION

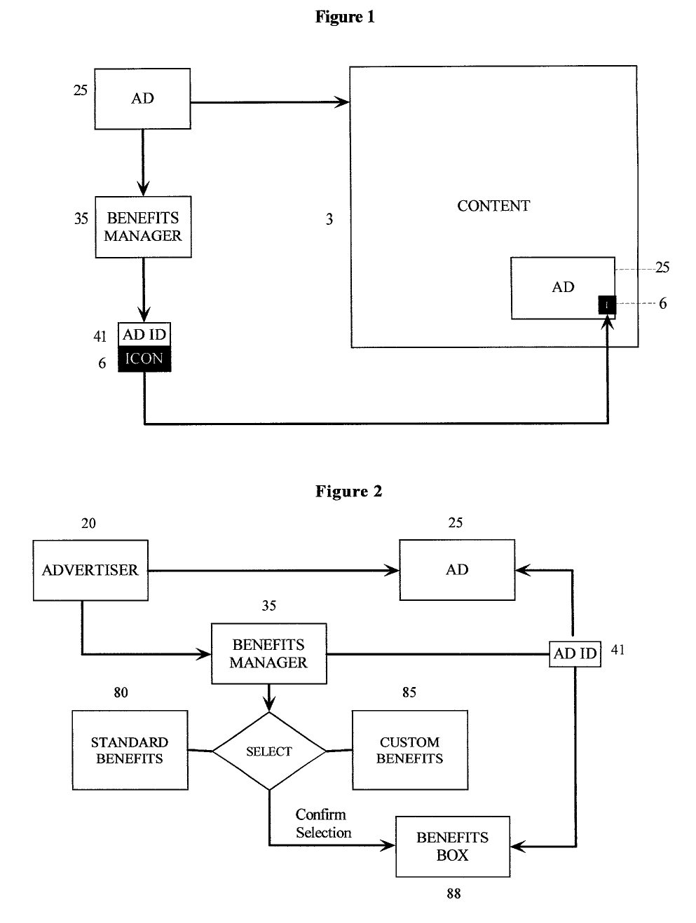

FIG. 1 shows Content 3 surrounding Ad 25. Ad 25 is entered in the benefits program of the present invention. An advertisement provider supplies Ad 25 to a content provider responsible for Content 3. Ad 25 is registered with Benefits Manager 35. Benefits Manager 35 creates Ad ID 41, an identity that corresponds to Ad 25. Ad ID 41 is joined to Icon 6. Icon 6 appears in a field within Ad 25. When a user clicks or otherwise acts upon Icon 6 the benefits program of the present invention is activated.

Depending on advertiser and program manager preferences the activation zone, the area where an action activates the benefits program, may be limited to an area within the borders of Icon 6, a region surrounding Icon 6 or anywhere within the borders of Ad 25.

FIG. 2 shows Advertiser 20 contacting Benefits Manager 35 and selecting or creating a benefits offering for use with the benefits program of the present invention. Advertiser, or client, 20 is presented with a choice of selecting Standard Benefits 80 or Custom Benefits 85. In a preferred embodiment, Standard Benefits 80 comprises an offer of three possible benefits: 1) a lottery, 2) points that are accrued toward the purchase of a free service or product and 3) a direct cash value award. Alternative embodiments may include more or different groups of benefit choices. A given selection of benefits is called a benefits box. The benefits offered to the user in the benefits box are tied to programs in which the user is likely to be already enrolled (such as a frequent flier program, a video rental program or a grocery store discount card); the user may select only one of them.

Custom Benefits 85 comprises a benefits program designed by the client herself. A client selecting Custom Benefits 85 is presented with a list of available benefits programs. Such benefits programs may include 1) travel and entertainment programs in which a user may already be enrolled; 2) coupon programs (for everything from CD players to hamburgers, donuts and haircuts) where users could receive free goods, services or discounts and 3) charitable donations programs which, upon being selected by the user, deliver funds to specified charities. The client selects as many of the programs as she wishes; the selections are used to create a custom benefits box that will be presented to the user.

After selecting Standard Benefits 80 or building a benefits box using Custom Benefits 85, the client confirms the selection. The confirmed selection becomes Benefits Box 88. Benefits Manager 35 assigns Ad ID 41 to Benefits Box 88. Ad ID 41 corresponds to Ad 25 and, as shown in FIG. 1, Icon 6. Benefits Box 88 is stored in a database and known in conjunction with Ad ID 41.

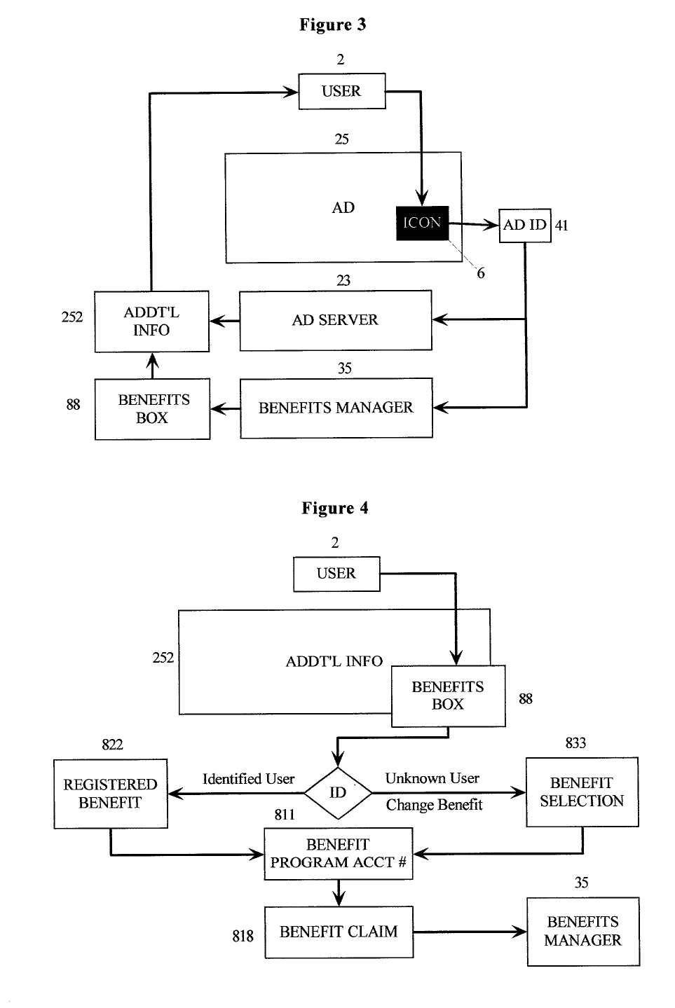

The purpose of the present invention is to motivate a user to seek additional information regarding a given advertisement. As shown in FIG. 3, Icon 6 informs a user that benefits may be claimed if the user accesses additional information by acting upon Icon 6. When User 2 acts upon Icon 6 within Ad 25, Ad ID 41 is sent to Ad Server 23 and Benefits Manager 35. Ad Server 23 retrieves Additional Information 252 corresponding to Ad 25. Benefits Manager 35 retrieves Benefits Box 88 corresponding to Ad 25. Additional Information 252 and Benefits Box 88 are sent approximately simultaneously to User 2.

FIG. 4 shows a process whereby a user claims benefits. User 2, having acted upon Icon 6 in FIG. 3, receives Additional Information 252 and Benefits Box 88 on his display device. User 2's display device interfaces with an Internet browser. If User 2 has previously registered with the benefits program his browser normally has a cookie that identifies Registered Benefit 822 and corresponding Benefit Program Account Number 811 and automatically sends Benefit claim 818 to Benefits manager 35.

If User 2 is unknown or wishes to change the benefit he previously selected he is directed to Benefit Selection 833—User 2 may select only one of the benefit programs. A user may be unknown because the user is acting upon Icon 6 for the first time, or because the user has deleted his browser's cookies. When selecting a benefit from Benefit Selection 833 User 2 enters Benefit Program Account Number 811. According to the invention Account Number 811 is the number of a user's already existing benefit program. For example a personal frequent flyer account number may be used as Account Number 811. It may further be needed that the user identifies the type of program to which the Account Number applies if the number does not intrinsically contain that type information. User 2 is then offered the opportunity to register with the program and receive a cookie so that further Benefit Selection 833 is unnecessary and Registered Benefit 822 is automatically entered as Benefit claim 811. After accepting or declining the cookie Benefit claim 818 incorporating Benefit Program Account Number 811 is sent to Benefits Manager 35.

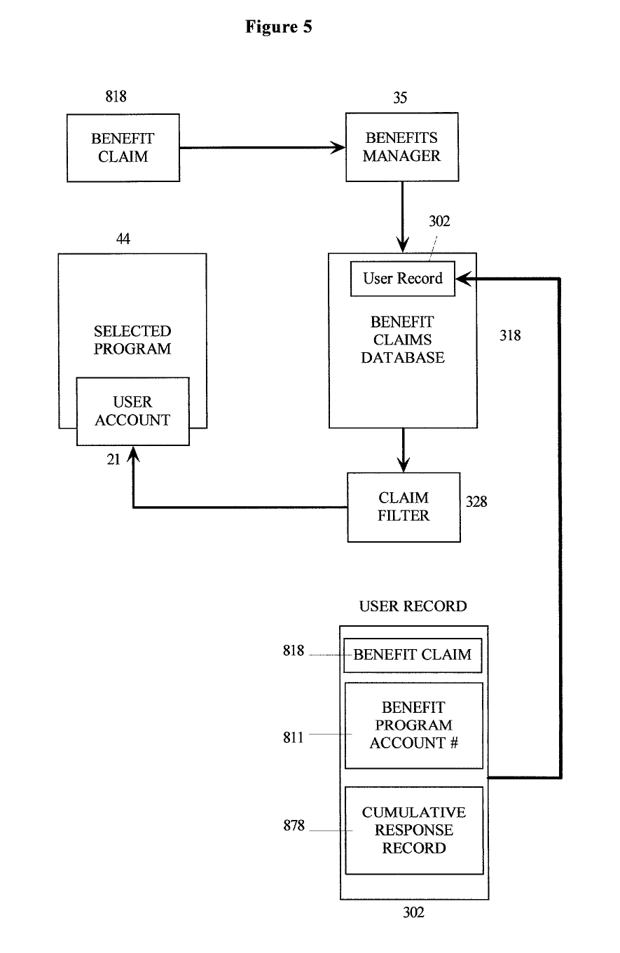

As shown in FIG. 5, Benefit claim 818 is sent to Benefits Manager 35 and entered into Benefit Claims Database 31 as User Record 302. User Record 302 is comprised of three elements: 1) Benefit claim 818 (incorporating the selected benefit program), 2) Benefit Program Account Number 811 and 3) Cumulative Response Record 878. Cumulative Response Record 878 compiles a record of each time Benefit claim 818 is entered into Benefit Claims Database 318 in conjunction with Benefit Program Account Number 811. Cumulative Response Record 878 is forwarded to Claim Filter 328. Claim Filter 328 incorporates a threshold level for the number of benefit claims that may be issued for User Record 302. The threshold may be tied to a time period. For example, Benefits Provider 35 may set the maximum threshold at 10 claims per two-day period, 5 claims per hour, 25 claims per month, etc. If the number of benefit claims recorded in Cumulative Response Record 878 is below the established threshold then an award is, or may be in the case of a lottery, entered into User Account 21 at Selected Program 44. User Account 21 is a specific account containing value and is represented and identified by Account Number 811. Program 44 is the selected third party benefit program to which the user has already identified himself. For example a user may have an account number assigned to his account within an airline's frequent flyer program.

If the number of claims for User Record 302 exceeds the threshold, a signal may be sent to the user informing him that a claim cannot be made.

In conjunction with the present invention advertising providers may track the value of benefits paid to users and may vary the benefits paid to different users responding to given advertisements. The basis for varying the payment of benefits may be, 1) value of demographic information supplied by users to the advertisement provider, 2) time of day and/or date, 3) value of benefits previously paid, 4) the subject matter and/or nature of the advertisement, 5) the location of the advertisement on a given web page or within a given web site, 6) numbers and timing of users responding (benefits may be high for early respondents and decrease after certain target response levels have been achieved or vice versa) or 7) other basis determined by the advertisement provider.

In the preferred embodiment, clients (advertisers, as contrasted to users) wishing to use the incentive program do so by visiting the benefits provider's web site, opening an account (providing billing and contact information) and selecting a benefits program comprised of either standard benefits or custom benefits. After the selecting a benefits program, the client enrolls a specific offer or set of offers in the program. Upon enrollment the client delivers the offer(s) (generally a banner ad and a web page—possibly through a third party such as an advertising agency or a media buying agency) to the benefits provider with instructions on where an icon signifying program participation and the subsequent benefits box should be located within the offer(s). The benefits provider enters an identifier in the icon so that it correlates to the client's specific offer(s).

Advertisement providers may register at a web site to enable the inclusion of advertising in the benefits program whereby users responding to the specified advertising may earn credits. When an advertisement provider registers, the provider may give a means of payment so that the cost of the credits and service charges may be automatically charged to the advertisement provider.

When a user of a display oriented device receives advertising via the network, an icon may be presented in conjunction with an advertisement. The icon may display information that tells a user the number of credits to be received for acknowledging the advertisement or electing to receive additional information related to it. Alternately the icon may not include a quantity of credits. The icon may appear superimposed, perhaps translucent, upon a small section of the advertisement. Alternatively the icon could appear in proximity to the advertisement.

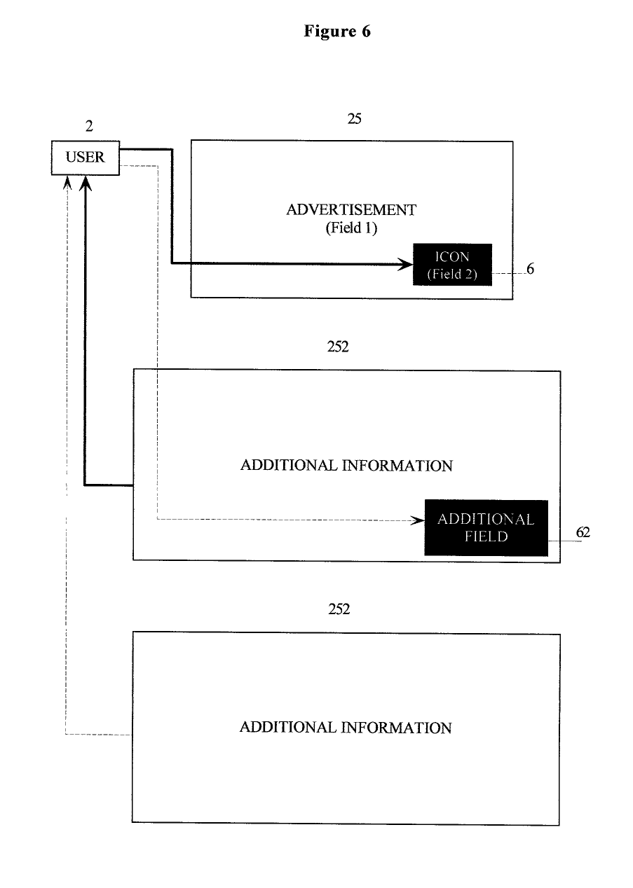

As shown in FIG. 6, Advertisement 25 may be initially rendered into two fields: a Field 1 in which the icon is not present and a Field 2 comprising an area covered by and/or proximate to the icon.

User 2 clicking or acting upon Field 1 receives only information related to Advertisement 25 without reference to the benefits program. If User 2 clicks or acts upon Field 2 he will receive information related to the advertisement in conjunction with the benefits program. The sizes of Fields 1 and 2 are not specified. In some embodiments Field 2 may completely overlap Field 1. Field 2 may also comprise small portion of the area covered by Field 1.

Subsequent to clicking or entering data into Field 2, the user may be presented with Additional Information 252, perhaps in the form of a web page or perhaps within the space of Advertisement 25 itself. In many cases this resulting page is a home page or other part of a web site of the advertiser. Additional Information 252 may include Additional Field 62 that, upon a click or other action, may present still more Additional Information 252 and possibly another Additional Field 62.

User actions in Icon 6 (Field 2) or Additional Field 62 cause benefits to be paid to the user in conjunction with the benefits program.

The advertiser or the agent may determine the value of benefits or credits issued to a user for one or a number of acknowledging actions. For example, clicking on the Field 2 of a given advertisement may earn a registered user 5 credits or 0 credits depending on the choice of the advertiser. In the same manner, clicking on Additional Fields may earn a range of credits. In this way users may receive additional incentives to read and consider additional information. The Additional Fields may be located within text or images comprising the additional information such that an Additional Field could be a single word, an image, an icon, or an action such as entering data on a form.

The present invention provides a means for preventing abuse of the credit awards system by automated computers. A registered user clicking or acting upon Field 2 may earn few or no credits, the action serving primarily to retrieve additional information with Additional Fields. Earning any credits or additional credits may require an action in one or more of the Additional Fields. Learning the information specified for the data entry in the Additional Fields may require reading information rendered from a graphics file format such as GIF, TIFF or JPEG and presented in pictorial or graphic form wherein the content is not easily readable as data or text by a computer program. The required act upon could vary from advertisement to advertisement. For example, presented within the additional information could be a graphics file of photograph of a paper with the words, “To earn 10 credits, enter the word ‘CAT’ in the box below”. A registered user reading the words in the photograph will thereby know to type in “CAT” to earn credits; an automated computer program reading data will not know that “CAT” is the password for earning credits. The Additional Fields may be provided by the benefits provider rather than the advertiser in the form of a pop-up box, where the box may or may not have a defined border within the field of the advertisement. In this way the benefits provider determines compliance so that the advertising provider or advertiser need not be concerned with the payment mechanism. Further, this helps the benefits provider to avoid interfering with the business of the advertising provider. In a further embodiment, this action requirement may become activated only after a registered user has claimed credits in conjunction with a specified number of advertisements. For example, for the first three advertisements viewed on a given day the requirements for claiming credits are clicks on icons in Field 2 or the Additional Fields; after credits have been claimed for three advertisements, the benefits provider activates a password entry requirement wherein the password is made disclosed in a graphics file and the password must be entered into an Additional Field for the user to receive credits. This password via graphics mechanism could also be applied with regard to data entries into Field 2.

In one embodiment of the present invention, if a user not registered for the benefits program clicks or acts upon the icon he is transferred to the registration page of the benefits program web site. Upon completing registration, or declining the opportunity to register, the user may receive additional advertising information. In an alternative embodiment, an unregistered user clicking on the advertisement receives additional advertising information wherein a registration box appears within the additional advertising; the registration box may enable immediate registration and participation in the benefits program. If the user wishes no involvement with the benefits program, the registration box may be canceled to remove it from within the advertising (typically the advertising would have the same look as would occur if the user had initially clicked on the advertising at a location away from the icon in Field 1 instead of in Field 2).

In one embodiment a user registered with the benefits program browses the Internet and accesses the web site of a content provider. The user's browser generates a message to get information for a desired web page. The content provider's web site, in response to the message, sends one or more messages back containing information to be displayed by the user's browser. The information includes one or more advertisements 25 that have been placed into specified locations within the information. The advertisements display icons 6 symbolizing participation in the benefits program (the icon on a given advertisement may display the number of credits that may be earned for a response). The icons are generated by a benefits provider computer, which upon being informed by means of an encoded message associated with the advertisement that a participating advertisement is being displayed at a given location on a web page, automatically delivers an icon and corresponding Field 2 to that particular advertisement. The advertising provider has been told by their advertisers which ads to include in the benefits program. The encoded message does not identify the contents of a related ad, but provides a notice to display a benefit, and may provide the amount of benefit to be paid. In this way the benefit provider may be unable to track the types of ads being viewed; the advertising provider retains that function and associated value.

The icon is displayed superimposed or in close proximity to the advertisement. When the icon is clicked or otherwise selected, a message is sent to the benefits provider's computer signaling a response to the benefits program. The cookie in his browser identifies the user's account by means of account number 811 and it is credited if the advertiser's encoded message requested crediting for clicking on the banner ad. The next page with the additional information is then delivered to the user's browser. The advertisement provider has previously assigned a number of credits to deliver to the user for responding to the advertisement in various ways. For example a user may get 5 credits for clicking on the banner, 10 credits for entering a word on the page that follows the banner, 20 credits for providing an email address on the second page following the banner and so on (the 10 credits and 20 credits in this example would be earned from responses entered into the Additional Fields). The signals to the benefits provider computer include identification of the registered user, identification of the advertisement and identification of the Field within the advertisement that the user is responding to. The benefits provider's computer recognizes the user's browser, the advertisement and the Field within the advertisement by means of a cookie or other digital identifier and delivers credits associated with the user's response to the advertisement into the user's account. The advertisement provider's account is automatically billed by the benefits provider for the value of the credits delivered to the user's account and for the cost of service. Generally, the computers supporting the browser, the content provider's web site, the advertising placed with the content provider and the benefits program server will be at different nodes on the Internet.

In a preferred embodiment the user's identity is limited to account number 811 of an existing benefit program to which the user already belongs. Such number would not comprise information that is commonly recognized as being valuable to third parties. Third parties may include advertisers, benefits program providers, and web site hosts. These third parties are distinct from the operators of third party benefit programs. Specifically such number would not facilitate a third party in gaining monetarily from the user nor in directly contacting the user. For example a social security number, credit card number, phone number, or email address would not be required to participate in the benefit program of the present invention.

The icon may appear in the comer of a banner advertisement, beside an item that is offered for sale, anywhere a client wishes a consumer to express interest by clicking or other action in the vicinity of the icon. An action in the vicinity of the icon causes a benefits box to appear in conjunction with a client's message. The benefits box offers first time users the choices of benefits previously determined by the client. The benefits box could offer, 1) a lottery for frequent flier miles, 2) points toward a free movie rental, 3) a discount on grocery purchases.

The benefits offered in the benefits box may be made in conjunction with programs 44 in which the user is already enrolled. A user selecting participation in the frequent flier lottery will select an airline and enter a frequent flier number. A user selecting participation in the free movie program will enter the number from a card associated with a video rental chain (such as Blockbuster). A user selecting participation in the discounts on groceries program will enter the number from the store discount card (and maybe a zip code and a store name, if the card number does not provide that information).

The three benefit options described above have in common that the identifying numbers are not inherently valuable to a third party. The user therefore remains substantially anonymous when using the benefit program. It follows that a user will require less compensation to respond to the benefit program of the present invention compared to a response to a typical prior art benefit program wherein a user must register with contact information at a benefit provider's web site.

If accepted by the user, the benefits box may enter a cookie into the user's browser incorporating the user's choice of benefits program and corresponding card account number. In return for additional benefits the user may accept a cookie that provides advertisers with additional information such as an email address. As described above, higher compensation is required since the user is no longer anonymous. The cookie stores the information in the user's browser. Whenever the user subsequently commits a signaling action in the vicinity of an icon the information is automatically retrieved so that the consumer is spared obviated registration steps. On subsequent visits, previously registered users see only the program for which they have registered; however, they are given the option to re-register and change programs.

However, the present invention also enables users to receive benefits without actively registering. The benefits manager can track the issuance of benefits to a user by means of the account identification number 811 the user enters to receive benefits.

Claiming the benefit may require the user to take some specific action. The action could be typing in the day of the week, a color, the name of the advertiser etc. (The instructions for the action may appear in a graphics format with low contrast so that an automated computer program cannot easily perform the function described in the instructions).

Once the specific action is taken, the user clicks on a button to claim the benefit. This action causes a signal to be sent to the benefits provider's computer where the user's identifier (such as a card number or, if the user has opted, an email address provided when registering) and a record of claims associated with that identifier are stored in a database. A maximum number of claims are allowable for a given period (the period may vary). If the benefits provider's computer determines that, with the addition of this claim, the total claims remain below the maximum claims allowable for the period, a signal is sent which activates the claim process. Alternatively, if the claim exceeds the maximum allowable for the period the user is informed that claims are not available at that time.

Once the claim process is enabled, if the benefit is a lottery, a lottery mechanism is activated at the benefits provider's computer and the user is told instantly if the user has won. If yes, then the award (perhaps 25,000 frequent flier miles, or free video rental) is automatically deposited in the user's account (using the account number from prior registration). If the benefit is points toward a product or service (such as a movie rental), the consumer is given confirmation that points have been earned. Likewise, if the benefit is a cash discount (such as on groceries or movie rentals), the consumer is given confirmation that a discount has been earned (the discount is applied to the appropriate card via the identification number). A benefit such as a coupon would be subsequently sent to the user electronically. A benefit such as a charitable donation would accrue in an account maintained by the benefits provider and be subsequently paid to the designated organization.

The benefits (frequent flier miles, movie rentals, grocery discounts, coupons, charitable donations and the like) paid to users in conjunction with the program are purchased by the benefits provider and paid for by automated means into supplier accounts.

When a user browsing the Internet with a device finds an offer with an icon and acts upon the icon a signal is sent to the benefits provider. The signal informs the benefits provider of the location of the offer with regard to the user's device. The benefits box, as previously determined by the client, is then delivered from the benefits provider to the specified location concurrent with subsequent information for the offer (a web page appears with the benefits box attached in the location previously determined by the client). If the user has previously registered, a description of his selected benefit appears and his only step is to claim the benefit. If the user has not registered he must choose a benefits program and provide identification information corresponding to the selected program (the information is then stored for subsequent visits).

The icon of the preferred embodiment may comprise a simple shape such as a square, triangle or circle (or a three dimensional incarnation such as a cube, pyramid or sphere). Within the shape may exist a field in which a symbol signifying value (such as “$”) is displayed. Alternatively the value symbol may be superimposed on top of the icon in either translucent or opaque form. The icon could be comprised of ornate and complex designs as well. In the preferred embodiment, the icon comprises a sugar cube.

When a user responds to the client's benefits box a signal is sent to the benefits provider where the client's account is credited for that response. When opening an account the client has provided a method of payment such as a credit card that may be billed automatically. On a periodic basis the client is charged for the fees that have accumulated in his account.

Alternatives to the preferred embodiment might utilize other programs in which the user already participates. Such programs could include travel cards, entertainment cards and credit cards from financial institutions and the like.

In common, preferred embodiments of the present invention offer three types of benefits within a standard benefits box: 1) a lottery with high value award, 2) points added to an account in which a given accumulation of points results in a free product or service and 3) a small cash discount that may be claimed quickly. A relationship among the three benefits offers exists such that each offer reflects the same unit cost. Thus, $0.05 could be translated into: 1) a cash discount of $0.05 on grocery purchases; 2) a single point valued at $0.05 wherein 50 points may purchase a movie rental valued at $2.50; 3) a lottery “ticket” valued at $0.05 wherein, at odds of 1/10,000 the “ticket” pays out at a value of $500 (the current cost for a marketer to purchase 25,000 frequent flier miles from American Airlines). This relationship could be applied in similar forms to coupons for goods and services as well as to charitable donations.

A custom benefits box may contain a single incentive option or ten or more options. The incentives offered in a custom benefits box could be comprised of opportunities for making charitable donations. In this incarnation the names of a number of charities would be displayed. When a charity is selected and a benefit is claimed on its behalf, the claim is recorded in an account maintained by the benefits provider. Using electronic means, the benefits provider pays the charity amounts that have accumulated in its account on a regular basis.

Clients may increase the incentive by adding to the values of the offers within the benefits box. With a standard benefits box each offer may be of equivalent value, thus simply adding the same value to the formulas used for calculating each benefit may increase the incentive. If a client wished to double the $0.05 incentive in the example described above, the payouts for the options would be: 1) a cash discount of $0.10; 2) two points toward a movie rental; 3) a lottery to win a $500 benefit with odds of 1/5000.

Rather than paying for the enhanced incentive themselves, marketers may find that suppliers of benefits or unaffiliated parties may contribute to the value of the offers made within the benefits box such that a contribution of $0.05 could be magnified into a benefit valued at $0.10 at no additional cost to the benefits provider or the marketer. In this instance the benefits offered may vary in value.

Enhanced value incentives may be communicated through the icon. Multiple units of the icon, or multiple units of the value symbol may be displayed to confer additional benefits. In a further embodiment a number could be displayed in proximity to the icon with a multiplication symbol to signify added value. For example: “2 X icon” could mean double incentives. Alternatively an icon of a given design could vary in color or in added dimensions) to signify enhanced incentives.

In a further embodiment, notification of winning the high value lottery award may be deferred until the next time the user participates in the program. In this manner abuse of the program may be further discouraged.

In alternative embodiments, the additional information may be delivered by an advertisement provider computer while the Additional Fields, supplied by the benefits provider's computer, may be placed, 1) within the additional information in spaces allocated by the advertisement provider, 2) superimposed on the additional information, 3) in proximity to the additional information, 4) on a page appearing before the additional information, or 5) on a page appearing after the additional information.

Additional Fields may appear subsequent to the appearance of additional information. In this way a user may choose to read and consider the additional information during the interval prior to the appearance of an Additional Field. When a user clicks or otherwise selects a Field 2 (corresponding to an icon), a message is sent to the benefits provider computer signaling a response to the benefits program; concurrently the advertisement provider's computer is sent a signal to send additional information. The advertisement provider's computer responds immediately to the request and sends the additional information to the user's browser. Before sending an Additional Field that will enable a user to earn credits, the benefits provider computer waits for either a) a pre-determined period of time or b) until a release Field signal is sent. The release Field signal tells the benefits provider computer that an Additional Field should be sent to the web page appearing on the user's device. The user's browser upon receiving the additional information could generate the release Field signal or the signal could be generated by the advertisement provider subsequent to sending the additional information. The release Field signal could also wait for a pre-determined period of time before being sent.

In a variation of the preferred embodiment the benefits provider computer may supply the icon and corresponding Field(s) to an advertisement provider that, in turn, compiles a participating advertisement with these elements of the benefits program and supplies the benefits embedded advertisement to a content provider. When the icon is clicked or otherwise selected, a message may be sent to the advertisement provider's computer signaling a response to the benefits program. The advertisement provider then signals the benefits provider to record a response and pay credits into a registered user's account.

Further embodiments may combine elements of the methods described above such that, alternatively, the benefits provider and/or the advertisement provider respond to the content provider either 1) one before the other, 2) one signaling the other to respond, 3) both responding directly to the advertisement provider, 4) one responding to the other that in turn compiles the elements of the advertisement and the benefits program and then responds to the content provider.

In one embodiment, the benefits provider alone or in conjunction with one or more advertisement providers, may award extra credits to random registered users who respond to participating advertisements. The credit awards may be made regularly or randomly. For example, the benefits provider could track the number of registered users clicking on icons or clicking or otherwise acting upon Additional Fields and award 25,000 credits to users who are the 100,000th, 200,000th, 300,000th registered users to respond. Other formulas could be used such as arithmetic or geometric progressions or other formulas; in concert with such formulas the amount of the credits could rise over time.

Example: extra credits are awarded to users corresponding with responses made in a geometric progression; number credits per award increase arithmetically. In this example responses corresponding to 10, 10×10, 10×10×10 etc. are awarded credits corresponding to 50, 50+50, 50+50+50 etc. In this manner the cost of the credits amortized per set of responses is reduced while the number of credits available as an incentive per single response grows.

This feature may enhance the perceived value of the benefits program while amortizing the cost of the increased benefits.

In order to collect credits a user opens an account with the benefits provider by visiting a web site where account information may be entered and /or retrieved. The user may enter demographic data and contact information that could be used by advertisers. The cookie the user receives from the benefits provider web site may thereafter supply demographic data and contact information upon request of advertisers, a) with or without notification to the user and b) with or without active approval from the user. The user may receive extra credits from program participants for providing demographic and contact information.

In an alternative embodiment, demographic data, contact information and even the identity of a user's browser may be made specifically unavailable to advertisement providers. In this embodiment users clicking or acting upon Field 2 have the benefits provider computer act as an agent. The benefits provider's computer requests information from the advertisement provider on behalf of the user and, upon receiving the information, transfers it to the user's browser.

The benefits program of the present invention may be utilized in conjunction with market research. In this embodiment users register with a web site and provide personal details rendered into keywords and other data that may be utilized by marketers wishing to assemble a survey group. Marketers may visit the web site and perform various searches by keywords and other data to locate an available pool of survey participants at the web site. If a large number of participants are available and only a small number are desired the web site may provide a means for randomly choosing from the pool of possible participants. The web site may offer the marketer templates of pre-determined compensation schemes whereby survey participants receive credits for participating in market research projects. The web site may also offer the marketer an option to create a customized compensation scheme. Compensation schemes may pay participants a number of credits per answer, per series of answers, upon completion of the project or upon other criteria as determined by the marketer. Once a compensation scheme has been selected (or created), it is presented, along with a synopsis of the project (estimated time commitment, subject matter, how to sign up to participate etc.), to a pool of desired participants by means of email, by postings at the web site in user accounts or by other means. Users wishing to participate in the project respond as specified in the synopsis. The marketer then confirms the members of the survey group and informs the benefits program of the names (accounts to be credited) of the survey group members. The marketer then interacts directly with the survey group without the involvement of the benefits provider. When group members complete credit-earning elements of the survey the marketer informs the benefits provider; the benefits provider then enters credits into the appropriate user accounts and charges the marketer a fee for the credits.

1. An incentive benefit program to encourage selected activities by users of a data network where a user is provided an opportunity to engage in the selected activity, and a benefit provider presents to the user an offer of compensation in return for the user electing to engage in the selected activity, wherein:
at least upon an initial opportunity to engage in the selected activity, the user instructs the benefit provider to assign the compensation to a pre-existing third party benefits program to which the user has previously joined;
the user being identified to the benefit provider by the identity of the benefit account, the user remaining substantially anonymous with respect to the benefit provider;
the compensation comprising additions of value to the benefits account.

2. The incentive benefit program of claim 1 wherein the third party benefits account comprises at least one of: a frequent flier program, a video rental program or a grocery store discount program.

3. The incentive benefit program of claim 1 wherein the third party benefits program is associated with a user by an account number, and the user maintains a relationship with a third party that operates the third party benefit program whereby the third party has access to information about the user that is of inherent value;
the inherent value comprising at least one of: an ability to directly contact the user, and an ability to gain monetarily from the user.

4. The incentive benefit program of claim 3 wherein the inherently valuable information about the user comprises at least one of: an email address, a home address, a business address, a home telephone number, a business telephone number, a credit card number, a driver license number and a social security number.

5. The incentive benefit program of claim 3 wherein the benefit provider has access to information about the user that is limited to the account number of the third party benefits program.

6. The incentive benefit program of claim 1 wherein the data network includes the Internet.

7. The incentive benefit program of claim 1 wherein the selected activity includes viewing advertisements provided by advertising providers on behalf of advertisers.

8. The incentive benefit program of claim 7 wherein the advertising provider has been told by advertisers which advertisements to include in the benefits program.

9. The incentive benefit program of claim 7 wherein the advertising provider has access to the inherently valuable information about the user.

10. The incentive benefit program of claim 1 wherein the benefit provider determines which third party benefits programs are available to the user for use with the incentive benefit program.

11. The incentive benefit program of claim 7 wherein the advertiser determines which third party benefits programs are available to the user for use with the incentive benefit program.

12. The incentive benefit program of claim 7 wherein the benefit provider and the advertising provider are independent entities.

13. The incentive benefit program of claim 7 wherein the benefit provider and the advertising provider are operated by a common entity.

14. The incentive program of claim 1 wherein a benefit incorporates a lottery mechanism.
